(19) United States
(12) Patent Application Publication
(10) Pub. No.: US 2010/0187354 A1
(43) Pub. Date: Jul. 29, 2010

(54) INFORMATION SYSTEM FOR MESSAGES FROM PASSENGERS TO THE CABIN CREW

(75) Inventor: Felix Helfrich, Hamburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/627,205

(22) Filed: Nov. 30, 2009

Related U.S. Application Data
(60) Provisional application No. 61/200,536, filed on Dec. 1, 2008.

(30) Foreign Application Priority Data
Dec. 1, 2008 (DE) 10 2008 059 823.2

(51) Int. Cl. B64D 11/00

(52) U.S. Cl. 244/118.5

(57) ABSTRACT

An embodiment of the invention relates to an information system for an aircraft, comprising an operating unit with input elements, by means of which operating unit a message from a passenger to the cabin crew can be input; and comprising a display unit, which is associated with a passenger and is arranged in the region of passenger accommodation, for displaying the message, wherein the operating unit makes it possible to input a message from several selection options. Furthermore, the invention relates to the use of such an information system.

### CROSS-REFERENCE TO RELATED APPLICATIONS

This application claims the benefit of the filing date of U.S. Provisional Patent Application No. 61/200,536 filed Dec. 1, 2008, the entire disclosure of which application is hereby incorporated herein by reference.

### BACKGROUND OF THE INVENTION

The invention relates to an information system for airplanes and to the use of such an information system.

On long-haul flights many passengers sleep or try to relax. In particular in flights that start late in the evening and that reach their destination as early as the next morning, some sleep is necessary to avoid arriving totally fatigued. However, up to now passengers have regularly been woken up, for example at meal times, although this does not always agree with their wishes.

### BRIEF SUMMARY OF THE INVENTION

It is the object of the invention to provide means to improve passenger convenience.

This object may be met by an information system and the use of the information system according to the independent claims.

Advantageous embodiments of the invention form part of the dependent claims.

One embodiment of the invention is based on the generic state of the art by providing an information system for an airplanes, comprising an operating unit with input elements, by means of which operating unit a message from a passenger to the cabin crew can be input; and comprising a display unit, which is associated with a passenger and is arranged in the region of passenger accommodation, for displaying the message, wherein the operating unit makes it possible to input a message from several selection options. This embodiment may be associated with the advantage in that with it passenger convenience can be significantly improved with low production costs. Furthermore, this also results in optimal sequences in the services provided by the cabin crew (for example, the information may be helpful for planning the distribution of meals). The information system may be associated with a further advantage in that it can be realised without considerable additional installation expenditure because it is possible to make use of already existing systems and displays.

According to a further embodiment, in each case an input element is associated with a particular message. This may allow quick and simple operation.

According to another embodiment, the message is transmittable from the operating unit exclusively to the display unit. This may result in a simple design with a minimum of cabling and thus minimisation of the overall weight of the aircraft.

According to a further embodiment, the information system can be coupled to an on-board communication system. This coupling to an on-board communication system (e.g. an in-flight entertainment system) that in most aircraft is already installed and that largely covers the entire aircraft, by means of which communication system up to now it has only been possible to transmit messages from the cabin crew to passengers, can advantageously be coupled to the information system according to the invention. This may provide an advantage in that messages from passengers to the cabin crew can be centrally collected and are thus available for planning the service sequences.

Furthermore, the invention provides for the use of the information system and an airplane comprising such an information system. This use and this aircraft may also provide the advantages described above.

### BRIEF DESCRIPTION OF THE DRAWINGS

FIG. 1 shows an information system according to a first embodiment;

FIG. 2 shows an information system according to a second embodiment; and

FIG. 3 shows an information system according to a third embodiment.

### DETAILED DESCRIPTION

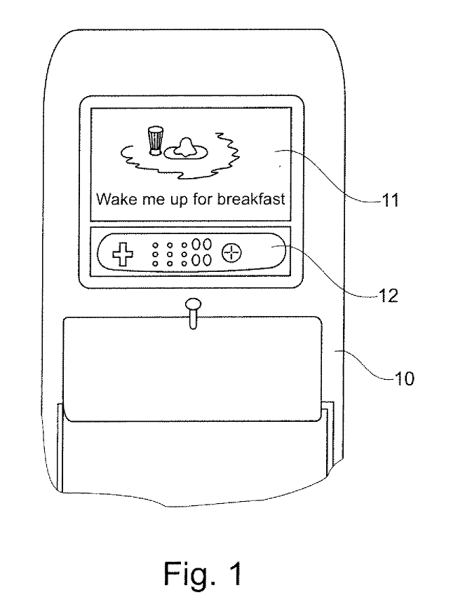

FIG. 1 shows an information system according to a first embodiment. A display unit 11 is installed in a passenger seat 10 of an airplane. In this embodiment the display unit 11 is a display screen which is installed approximately at head height on the rear of the passenger seat 10. The display unit 11 is allocated to a passenger who is seated behind (as seen in longitudinal direction of the airplane) the passenger seat 10 shown. Furthermore, an operating unit 12 is provided which in this embodiment is designed in the form of a remote control device comprising keys. The operating unit 12 can transmit passenger input to the display unit 11, either by way of electrical cables or in a wireless manner. Furthermore it is possible for the operating unit and the display unit to be provided so as to be combined, in other words located in a single housing, for example in the form of keys located directly on or beside the display screen surface of the display unit or in the form of a touch screen. By way of corresponding keys of the operating unit 12 the passenger can select messages addressed to the cabin crew, which messages are to be displayed to the cabin crew while the passenger is asleep. For example, the messages can show that the passenger does not wish to be disturbed, would like to be woken up for duty-free sales or for catering. Generally speaking, the display unit 10 is to inform the cabin crew whether or not a passenger wishes to be disturbed/woken up, and if so, if applicable also the point in time at which wakeup is to take place (e.g. 30 minutes prior to landing). Apart from this function the display unit 10 can also comprise the already known functionalities, for example the presentation of flight entertainment films or the like. This means that the information system according to the invention can be coupled to the on-board communication system that often already exists. In such an on-board communication system the display units can be centrally controlled so that flight entertainment films or messages can be provided to passengers. By coupling the information system according to the invention to this on-board communication system, the messages from passengers to the cabin crew can be centrally collected and centrally communicated to the cabin crew. This makes it possible to achieve improved organisation of services. Moreover it should be added that in addition to the display unit 11 the normal service light (not shown) in the passenger region can be provided, by means of which service light a passenger requests immediate service from the cabin crew but is not able to send a time-offset message to the cabin crew. Below, further embodiments are described in which only the differences to the first embodiment are shown.

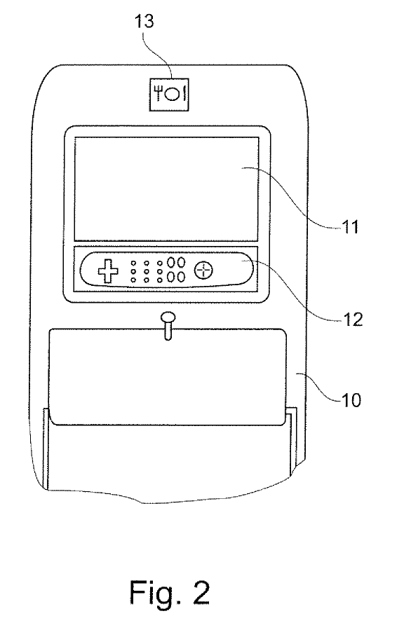

FIG. 2 shows an information system according to a second embodiment. In a manner that differs from that of the preceding embodiment, in this embodiment a display unit 13 in the form of a small display is integrated in the passenger seat 10. This small display is exclusively used to display messages to the cabin crew; it can, for example, be a light (or an LCD) or the like. This display unit 13 can be controlled by way of the operating unit 12 in the form of a remote control device. As an alternative to this it is also possible for keys to be provided beside the display unit 13, which keys exclusively communicate with the display unit 13.

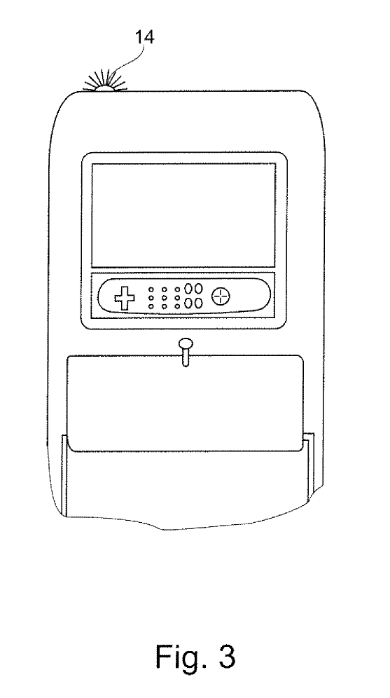

FIG. 3 shows an information system according to a third embodiment. In this embodiment a display unit 14 in the form of a light is integrated in the passenger seat 10. This light can, for example, be a LED that glows in various colours. In this arrangement, depending on the input by way of the operating unit 12, the light glows in a different colour which indicates to the cabin crew how the particular passenger would like to be treated in certain situations, i.e. whether or not the passenger wishes to be woken up/disturbed. As an alternative to this it is also possible for the display unit 14 to be provided in the passenger service unit (PSU), which is normally arranged in the overhead region of the passenger.

1. An information system for an airplane, comprising:
an operating unit with input elements, by means of which a message from a passenger to the cabin crew can be input; and
a display unit, which is associated with a passenger and is arranged in the region of passenger accommodation, for displaying the message,
wherein the operating unit allows input of a message from several selection options.

2. The information system of claim 1, wherein in each case an input element is associated with a particular message.

3. The information system of claim 1, wherein the message is transmittable from the operating unit exclusively to the display unit.

4. The information system of claim 1, wherein the information system can be coupled to an on-board communication system.

5. The use of an information system according to claim 1 for the advance provision of information by the passenger, which information relates to some future behaviour of the cabin crew in relation to said passenger.

6. The use according to claim 5, wherein the information system informs the cabin crew whether and/or when the passenger wishes to be woken up for upcoming events.

7. An aircraft comprising an information system of claim 1.
